(19) United States
(12) Patent Application Publication
(10) Pub. No.: US 2010/0116690 A1
(43) Pub. Date: May 13, 2010

(54) Detection of Chiral Alcohols and Other Analytes

(75) Inventors: Ritu Kataky, Durham (GB); David Parker, Durham (GB)

Correspondence Address: FOLEY HOAG, LLP;PATENT GROUP, WORLD TRADE CENTER WEST, 155 SEAPORT BLVD, BOSTON, MA, 02110, US

(73) Assignee: University of Durham, Durham (GB)

(21) Appl. No.: 12/524,938

(22) PCT Filed: Jan. 29, 2008
(86) PCT No.: PCT/GB08/50055

§ 371 Date: Dec. 23, 2009

(30) Foreign Application Priority Data
Jan. 29, 2007 (GB) GB 0701599.3

(51) Int. Cl. G01N 27/26; C07F 17/02

(52) U.S. Cl. 205/777.5; 205/782; 204/400; 205/775; 546/12

(57) ABSTRACT

Various methods, compounds and apparatus for the detection of analytes are provided. In one aspect, the direct oxidation of an alcohol is detected electrochemically. In another aspect, a reaction of an analyte is detected, wherein the reaction is catalysed by an enzyme and a cofactor, and wherein the cofactor comprises a moiety which is capable of acting as an electron mediator. In a further aspect, a chiral analyte is detected by resolving a enantiomeric mixture of the analyte and subsequently detecting at least one of the resolved enantiomers electrochemically. The invention is particularly relevant to the detection of alcohols, especially chiral alcohols.

### FIELD OF THE INVENTION

This invention relates to methods, compounds and apparatus for the detection of analytes, in particular chiral analytes such as chiral alcohols.

### BACKGROUND TO THE INVENTION

The ability to determine enantiomeric excess is crucial to the pharmaceutical and chemical industries. For example, in the case of pharmaceutical compounds one enantiomer may be therapeutically active, whereas the other enantiomer may be inactive or even toxic. Since chiral alcohols, e.g. 1-phenylethanol, are important intermediates in the synthesis of many pharmaceutical compounds, there is considerable interest in techniques for determining enantiomeric excess of such compounds.

Chirality may be probed using chiral chromatography techniques, for example chiral gas chromatography (GC) or high performance liquid chromatography (HPLC). The basic GC set-up for enantiomer separation typically utilises a long, coiled column which is coated with a chiral stationary phase (CSP) along its inner walls. Gaseous sample is injected into the path of an inert carrier gas and swept through the column along with the carrier gas. As the sample passes along the column, it transiently interacts with the chiral stationary phase. The chiral environment causes each enantiomer to interact with the CSP with different binding energies. Enantiomers which strongly bind to the CSP will take longer to move along the column (i.e. have a greater retention time), causing the weaker bound enantiomers to elute first. The size of the column is proportional to the degree of separation. HPLC works on the same principle as GC, except that the sample is present in solution, and a liquid mobile phase sweeps the sample through the column. Enantiomeric excess may be detected using either of these techniques, however these methods generally involve the use of bulky, costly machinery. Furthermore, chromatographic techniques are primarily laboratory-based and time consuming.

Chirality can also be probed using nuclear magnetic resonance (NMR). Enantiomers have identical physical and chemical properties, resulting in identical chemical shifts. However, if the racemate is initially reacted with a single enantiomer of another molecule, a pair of diastereoisomers will be created. Diastereoisomers have different chemical and physical properties, and hence slightly different NMR shifts. By recording the NMR of the diastereoisomer mixture and integrating the peaks, it is possible to calculate the ratio of enantiomers in the sample. Enantiomeric excess can also be determined using chiral NMR, but this requires various reaction steps to be carried out in order to bind a chiral derivatizing agent to the analyte. Furthermore, the chiral solvating agents used in such processes are not readily available.

Enzymes have been exploited in chiral resolution, as a result of their accuracy, precision and sensitivity. Resolutions involving enzymes also tend to require less sample preparation, offering high activity and enantioselectivity under mild reaction conditions. For example, alcohol dehydrogenase (ADH) is a zinc metalloenzyme which catalyses the reversible alcohol to carbonyl conversion. ADH is found in many species and requires a nicotinamide adenine dinucleotide (NADH/NAD⁺) cofactor to function. As the active site of the enzyme is chiral, ADH can catalyse alcohol oxidations with a high degree of stereoselectivity. Various ADH mimics have been synthesised, including polyamine macrocycles (e.g. polytriamines). Mimics of the NAD⁺/NADH cofactor have also been developed.

Electrochemical methods for the determination of enantiomeric excess have had very limited success. Efforts have focused on detecting the oxidation of chiral alcohols, but alcohol oxidations have been found to occur at potentials too high to be detected directly when methods such as cyclic voltammetry (CV) and square wave voltammetry (SWV) are used.

Although enzymes have been incorporated into electrochemical sensors, their use can pose significant problems. For example, the potentials required to achieve alcohol oxidations can cause cofactor dimerisation, as observed in the case of NADH/NAD⁺ cofactors. This problem can be overcome to some extent by using an electron mediator, i.e. an agent which facilitates electron transfer between the electrode and substrate (or vice versa) at lower potentials. Nitroxyl radicals and particularly their corresponding nitrosonium cations have been frequently used as electron mediators in the selective oxidation of alcohols. An example of a nitroxyl electron mediator is 2,2,6,6-tetramethylpiperidine-1-oxide (“TEMPO”). TEMPO undergoes a one-electron oxidation in acetonitrile at approximately 0.4 V (vs. Ag/AgNO₃).

The electrochemical oxidation of alcohols can be enhanced using a base (proton abstractor) which aids abstraction of the proton of the alcoholic oxygen atom. Where the base is a chiral base, resolution of a chiral alcohol may be possible. For example, Kashiwagi et al (Chem. Commun., 1996, 2745) describe that (−)-sparteine can be used to electrochemically resolve 1-phenylethanol. However, a limitation of this system is that an electron mediator (e.g. TEMPO) must be present for detection to be possible. Furthermore, Belgsir et al (Chem. Comm. 1999, 435) claim that these results are irreproducible and that the TEMPO cation causes oxidation of the (−)-sparteine to an iminium ion.

### SUMMARY OF THE INVENTION

The present invention is based in part on a discovery that alcohols can undergo a direct, 2-electron oxidation at the surface of an electrode, the oxidation being electrochemically detectable. Furthermore, when a chiral base is used, an enantioselective response may be obtained in the absence of an electron mediator.

Accordingly, a first aspect of the present invention provides a method of detecting an alcohol in a sample, which comprises:
(a) contacting the sample with working and counter electrodes in the presence of an electrolyte, wherein the contacting takes place under conditions such that the alcohol undergoes direct oxidation at the working electrode; and
(b) determining the electrochemical response of the working electrode to said direct oxidation.

The present invention is also based in part on a discovery that the enantioselectivity of alcohol dehydrogenases and other enzymes can be enhanced through the use of a cofactor comprising an electron mediator functionality. Including an electron mediator in a cofactor ensures the components are in close proximity, and thus may lead to an enhanced response. Electron transfer between the mediator and cofactor may be more favourable when the process is intramolecular, resulting in faster coenzyme regeneration and more efficient catalysis.

Accordingly, in another aspect the invention provides a method of detecting an analyte in a sample, comprising:
(a) contacting the sample with an enzyme and a cofactor, wherein the enzyme and the cofactor catalyse a detectable reaction of said analyte, and wherein the cofactor is capable of acting as an electron mediator; and
(b) detecting said reaction.

Also provided is a cofactor for an enzyme, wherein the cofactor is capable of acting as an electron mediator. An electrochemical sensor comprising said cofactor is also provided.

The present invention also provides a novel sensor for the detection of chiral analytes, which comprises chiral resolution means and an electrochemical sensor. Sensors of the invention may have a low limit of detection, portable, cheap, of simple set-up and quick to use compared with conventional detection apparatus.

Thus, in a further aspect the invention provides a sensor for detecting a chiral analyte, comprising:
(a) means for resolving enantiomers of said analyte; and
(b) an electrochemical sensor for detecting at least one resolved enantiomer.

Also provided is a method of detecting a chiral analyte in a sample, which comprises:
(a) resolving an enantiomeric mixture of said analyte; and
(b) detecting at least one of said separated enantiomers electrochemically.

### BRIEF DESCRIPTION OF THE DRAWINGS

FIG. 1 depicts an embodiment of a sensor of the invention.

FIG. 2 shows is a cyclic voltammogram (CV) showing the concentration dependence of the 2.2 V peak on 1-phenylethanol (PE). Solutions contained 0.15 mM TEMPO, 0.02 M 2,6-lutidine, 0.2 M NaClO₄, and variable PE concentration (50 mV/s, Pt).

FIG. 3 is a square wave voltammogram showing the pre-adsorption peak occurring on the PE oxidation peak.

FIG. 4 is a chart comparing ferrocene and PE peak currents. The CVs were base-line corrected, and peak current was measured relative to this. Solutions contained 0.2 M NaClO₄ and 10 mM ferrocene and 10 mM PE.

FIG. 5 is a chart showing enantioselectivity with (−)-sparteine base towards S-PE. The BG solution contained 0.15 mM TEMPO, 0.02 M (−)-sparteine and 0.2 M NaClO₄.

FIG. 6 shows various square wave voltammograms obtained with R- and S-PE.

FIG. 7 is a chart showing the enantioselectivity found with a chiral cofactor-mediator and horse liver ADH.

### DESCRIPTION OF VARIOUS EMBODIMENTS

According to one aspect of the present invention, the presence of an alcohol in a sample may be detected via a direct oxidation process. The sample may be contacted with working and counter electrodes in the presence of an electrolyte under conditions such that the alcohol undergoes oxidative adsorption at the working electrode. The electrochemical response of the working electrode to said oxidation may then determined. The method may take place under conditions such that oxidative adsorption of the alcohol occurs.

The invention is particularly relevant to the detection of alcohols used in the pharmaceutical industry, e.g. secondary alcohols and aminoalcohols. The alcohol may be a chiral alcohol, the term “chiral alcohol” as used herein including reference to compounds comprising an alcohol group attached directly to a chiral centre. A particular chiral alcohol of interest is 1-phenylethanol. A chiral alcohol may be in the form of an enantiomeric mixture (e.g. a racemate) or a substantially pure form of an enantiomer.

In a particular embodiment, detection takes place in the presence of a base. Use of a base may aid abstraction of the alcoholic proton. Exemplary bases include 2,6-lutidine and (−)-sparteine. Where enantioselective detection of a chiral alcohol is desired, use of a chiral base, for example (−)-sparteine, may be desirable.

The working electrode generally comprises a material on which the chiral alcohol can undergo oxidative adsorption. In a preferred embodiment, the working electrode comprises platinum. The counter electrode may be any suitable electrode known in the art. For example, the counter electrode may comprise platinum. A reference or pseudo-reference electrode may also be used. In a particular embodiment, a platinum wire pseudo-reference electrode is used.

The electrolyte is typically present in solution. The electrolyte may be, for example, sodium perchlorate. In one embodiment, an electrolyte comprising sodium perchlorate dissolved in acetonitrile is used. An aqueous or organic solvent may be used. Of particular mention are systems comprising an organic solvent, for example acetonitrile.

In most cases, the alcohol will be oxidised to form a carbonyl compound, e.g. an aldehyde or a ketone. The alcohol may undergo direct oxidation upon adsorption at the working electrode. This process is illustrated below using a platinum electrode as an example:

Pt+R₂CHOH→Pt—(R₂CHOH)_{(ads)}

Pt—(R₂CHOH)_{(ads)}→Pt+R₂C═O+2H⁺+2e⁻

The sample may be in liquid or gaseous form. Where the sample is gaseous, it may be bubbled into a solution of the electrolyte, where it is contacted with the electrodes.

In another aspect, the present invention provides a method of detecting an analyte which involves the use of a cofactor comprising an electron mediator functionality. In embodiments, the cofactor is a chiral cofactor.

The analyte may be any chiral analyte which is capable of undergoing a detectable enzyme-catalysed reaction. In one embodiment, the analyte is a chiral alcohol. A particular chiral alcohol of interest is 1-phenylethanol. A chiral alcohol may be in the form of a enantiomeric mixture (e.g. a racemate) or a substantially pure form of an enantiomer.

The enzyme is capable of catalysing a detectable reaction of the analyte. The term “enzyme” as used herein includes reference to enzymes, enzyme mimics (including cyclodextrin-based mimics) and other compounds which catalyse a detectable reaction of the analyte. The enzyme is preferably a chiral enzyme. Of particular mention are enzymes which catalyse the oxidation of chiral alcohols, e.g. alcohol dehydrogenases and mimics (e.g. polyamine macrocycles such as polytriamines) thereof.

The cofactor may comprise any cofactor for the enzyme being utilised. Particularly when the enzyme is an alcohol dehydrogenase, the cofactor may comprise a nicotinamide moiety or a derivative thereof. The cofactor may be in oxidized or reduced form. Where detection of a chiral analyte is required, the cofactor is preferably chiral.

The electron mediator functionality of the cofactor is generally capable of facilitating electron transfer, e.g. between the electrode and the analyte or vice versa. The electron mediator is typically covalently bound, optionally via a linker, to the cofactor functionality. Examples of electron mediating moieties include ferrocenes, anthracenes and anthraquinones. Of particular mention are ferrocenyl groups. Ferrocenes have a well-characterized redox behaviour and oxidation to the ferrocenium ion occurs at much lower potentials than those which result in cofactor degradation. Furthermore, ferrocene comprises a stable, delocalized system and is therefore unlikely to cross-react during synthesis.

In one embodiment, the chiral cofactor comprises a nicotinamide moiety and a ferrocenyl moiety. An example of such a cofactor is a compound of the formula (I) or a derivative thereof:

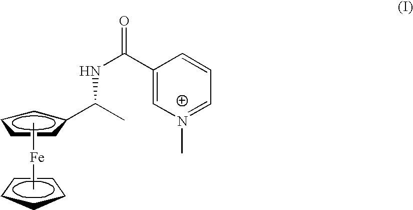

By way of illustration and without limitation, the chiral cofactor may act as follows. On addition of the analyte, some of the analyte may be oxidised by the enzyme, forming the cofactor in its reduced state. Potential will be increased as a consequence and the electron mediator functionality will become oxidized. The reduced cofactor will then be oxidised by the oxidized electron mediator and go on to react with more analyte. The electron mediator will then be re-oxidised at the working electrode and the process will keep on repeating. The analyte may be detected, for example, by determining the ionization potential (iₚ) of the electron mediator functionality. The scheme below illustrates how this process in the case of the oxidation of 1-phenylethanol (PE) in the presence of alcohol dehydrogenase (ADH) and a chiral cofactor comprising nicotinamide (NAD) and ferrocenyl moieties:

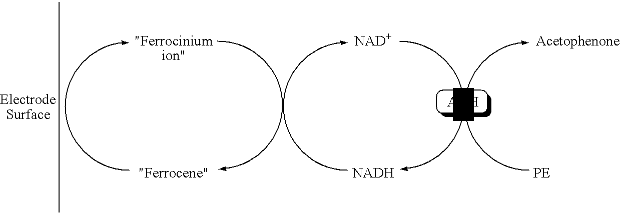

A chiral cofactor of the invention may be synthesised according to the reaction scheme described in Example 3. It will be understood that the processes detailed herein are solely for the purpose of illustrating the invention and should not be construed as limiting. A process utilising similar or analogous reagents and/or conditions known to one skilled in the art may also be used to obtain a compound of the invention. Any mixtures of final products or intermediates obtained can be separated on the basis of the physico-chemical differences of the constituents, in a known manner, into the pure final products or intermediates, for example by chromatography, distillation, fractional crystallisation, or by the formation of a salt if appropriate or possible under the circumstances.

The reaction may be detected electrochemically or optically. Where optical detection is employed, a cofactor comprising one or more chromophores may be used. Exemplary chromophores include metalloporphyrins and the like.

In a further aspect, the present invention provides a sensor for detecting a chiral analyte which comprises chiral resolution means and an electrochemical sensor. Methods of detection of chiral analytes comprising chiral resolution and electrochemical detection techniques are also provided.

Resolution may be performed using any suitable technique known in the art, for example chiral chromatography. Chiral membranes (e.g. comprising a polymeric material comprising a chiral recognition moiety, for example a β-cyclodextrin), chiral ionic liquids and solutions comprising chiral recognition moieties may also be used.

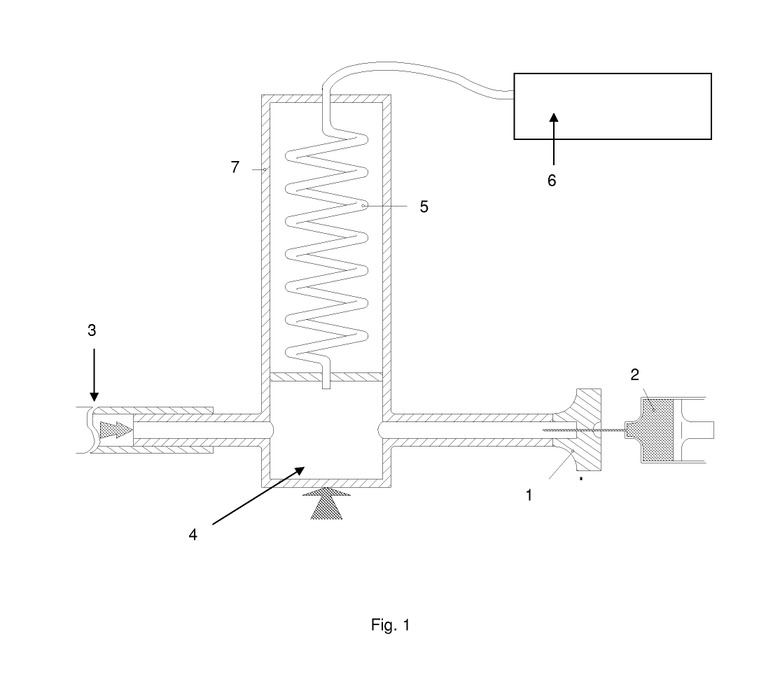

By way of illustration, a sensor of the invention is shown in FIG. 1. The sensor comprises an inlet 1 through which a sample may be injected, e.g. using syringe 2, and an inlet 3 for a carrier gas, said inlets leading to a vaporisation chamber 4. The vaporisation chamber comprises an outlet leading to a chiral chromatography column 5. The uppermost portion of the column comprises an outlet which leads to an electrochemical sensor 6. The electrochemical sensor comprises working and counter electrodes and an electrolyte (not shown), and is able to detect enantiomers as and when they are eluted from the column. Particularly when a suitable electrocatalyst is present, the sensor may be able to assess enantiomeric excess of high energy redox active species. Thus, the electrochemical sensor may comprise an electrocatalyst. The sensor may be housed in a suitable casing 7, for example a steel casing.

In use, liquid sample is injected through the sample inlet and flows into the vaporisation chamber. The sample is subsequently vaporised and forced by the carrier gas through the outlet of the vaporisation chamber and through the chiral chromatography column. Enantiomers are eluted in the column and are carried towards the electrochemical sensor, which can detect their sequential evolution. The electrochemical sensor may, for example, give a current reading proportional to each enantiomer concentration. For example, when a first enantiomer is eluted, the current (or potential) will change until all of the first enantiomer has been eluted (i.e. a constant concentration). This value should then be noted. When a second enantiomer is eluted, the current will change again, until all of the second enantiomer has been eluted. This stable current should again be noted, and represents the total concentration of the analyte. Calibration curves corresponding to iₚ as a function of analyte concentration can then be consulted, giving the concentration of the original solution and the initial enantiomer. The concentration of the second enantiomer can then be found by subtracting the first enantiomer concentration from the initial enantiomer concentration. From these three values, enantiomeric excess may be calculated. Alternatively, if the elution time difference is large, the initial enantiomer will deplete and the current will fall, resulting in a peak rather than a plateau. In this case the two peak currents should be noted, corresponding to the first and second enantiomer concentrations directly. Performance of the sensor can be optimised by, for example, varying the column length and heating methods employed.

Where a method or sensor of the invention relies on electrochemical techniques to detect an analyte, it will be appreciated that the electrochemical response may be determined using any suitable technique known in the art. This typically involves applying a potential across working and counter electrodes, and determining the response of the working electrode to the sample. A potential may be applied across the electrodes using a potentiostat, and the response of the cell to the sample determined. The sample may be in liquid or gaseous form. Where the sample is gaseous, it may be bubbled into a solution of the electrolyte, where it is contacted with the electrodes.

Various electrochemical techniques, for example voltammetry (e.g. cyclic voltammetry), potentiometry and amperometry, are encompassed by the present invention. For determination of the voltammetric response, the applied potential is varied relative to a reference electrode; in this way, a cyclic voltammogram may be obtained. Alternatively, the amperometric response of the cell can be determined by applying a fixed potential across the electrodes, optionally controlled relative to a reference electrode. The reference electrode may be, for example, a saturated calomel electrode (SCE) or a silver electrode. The shift of redox potential may be unique to a particular process and provide a potentiometric signal.

Methods and sensors of the invention may be suitable for high throughput analysis. For example, a sensor of the invention may comprise a plurality of wells or other chambers for different samples, e.g. in the form of recessed or protruding microelectrode arrays, allowing simultaneous detection of multiple analytes.

The following Examples illustrate the invention.

Unless otherwise stated, all materials were obtained and used without further purification. TEMPO, 2,6-lutidine, sodium perchlorate (NaClO₄), (−)-sparteine, (R)—N,N-dimethyl-1-ferrocenylethylamine, acetic anhydride, phosphoric acid, methyl iodide (MeI), N-methylmorpholine (NMM), N-(3-dimethylaminopropyl)-N′-ethyl carbodiimide hydrochloride (EDC), 1-hydroxybenzotriazole (HOBt), nicotinic acid, sodium carbonate, sodium bicarbonate, sodium chloride (NaCl) and (s)-mandelic acid were all obtained from Sigma-Aldrich. TEMPO and solutions thereof were stored in a fridge. Before use, the solutions were allowed to warm to room temperature (25° C.) for 15 minutes. Racemic 1-phenylethanol (PE), acetophenone, S-PE, R-PE, (−)-sparteine sulfate, polyvinyl chloride (PVC), potassium tetrakis(4-chlorophenyl)borate, bis(1-butyl pentyl)adipate (BBPA) and horse liver ADH were all obtained from Fluka. The enzymes were stored in a freezer prior to use. Potassium chloride (KCl) was obtained from BDH laboratory supplies. Deuterated chloroform (CDCl₃) and deuterated water (D₂O) were obtained from Goss Scientific Instruments, Limited. Acetonitrile, DCM, methanol, ammonia, ethanol, hydrochloric acid, THF, hexane, EtOAc and diethyl ether were obtained from Fisher Scientific. Platinum (Pt) and glassy carbon (GCE) working electrodes (WE), Ag/AgCl and Ag/AgNO₃ reference electrodes and Pt flag counter (auxiliary) electrodes were all obtained from BASi. Alumina slurry micro polish was obtained from Buehler. Ferrocene was obtained from Avocado.

Unless otherwise stated all of the following electrochemical experiments were conducted in a single-compartment glass cell placed within a Faradic cage. The working electrode (WE) was polished manually with alumina slurry between experiments. CCVs, SWVs and chronoamperometric data were performed with a three-electrode potentiostat (EG and G Princeton Applied Research, model 263) on unstirred solutions. The programme used to record the experiments was Powersuite. Repeat scans were made where appropriate.

### Example 1

### Detection of 1-phenylethanol by Direct Oxidation

### Experimental

A solution containing 95% acetonitrile to 5% water (v/v) was prepared. This was used to prepare a solution (250 cm³) containing a NaClO₄ (0.2 M) supporting electrolyte. This was used as the ‘solvent’ for all solutions detailed in this section. Three BG solutions (10 cm³) were made up and characterized by CV and SWV (0-2.4 V, at 100 mV/s). These contained ‘solvent’, TEMPO (0.15 mM); and TEMPO (0.15 mM), 2,6-lutidine (0.02 M)

Solutions (10 cm³) containing TEMPO (0.15 mM), 2,6-lutidine (0.02 M), and various PE concentrations (1 mM, 5 mM, 8 mM, 10 mM and 15 mM) were then made up. These solutions were characterized by CV (between 0 V and 2.4 V, at 10 mV/s, 25 mV/s, 50 mV/s, 100 mV/s, 200 mV/s, 300 mV/s and 500 mV/s) and SWV (0-2.4V, at 100 mV/s). The pH of these solutions was measured with a pH electrode (Mettler Toledo, model Seven Multi). The average pH was 8.7. The following control solutions were made and characterized by CV (between 0V and 2.4 V, at 50 mV/s): PE (10 mM); ethanol (10 mM); and ferrocene (10 mM).

A Pt electrode was used as the working electrode, along with a Pt flag auxiliary electrode and a Pt wire pseudo-reference electrode.

The solutions were also characterized by linear sweep voltammetry (0-2.4 V, 50 mV/s). A different three-electrode potentiostat was used (EG and G Princeton Applied Research, model 273), along with a rotating platinum disk electrode (EG and G Princeton Applied Research, model 616) as working electrode (the reference and counter electrode were the same as mentioned above). The rotating disk electrode was set at twenty revolutions per minute.

Solutions containing TEMPO (0.15 mM) and various 2,6-lutidine concentrations (50 mM and 5 mM) were also prepared and characterized by CV (between 0 V and 1.5 V, at 50 mV/s). Both platinum and glassy carbon working electrodes were tested.

### Results

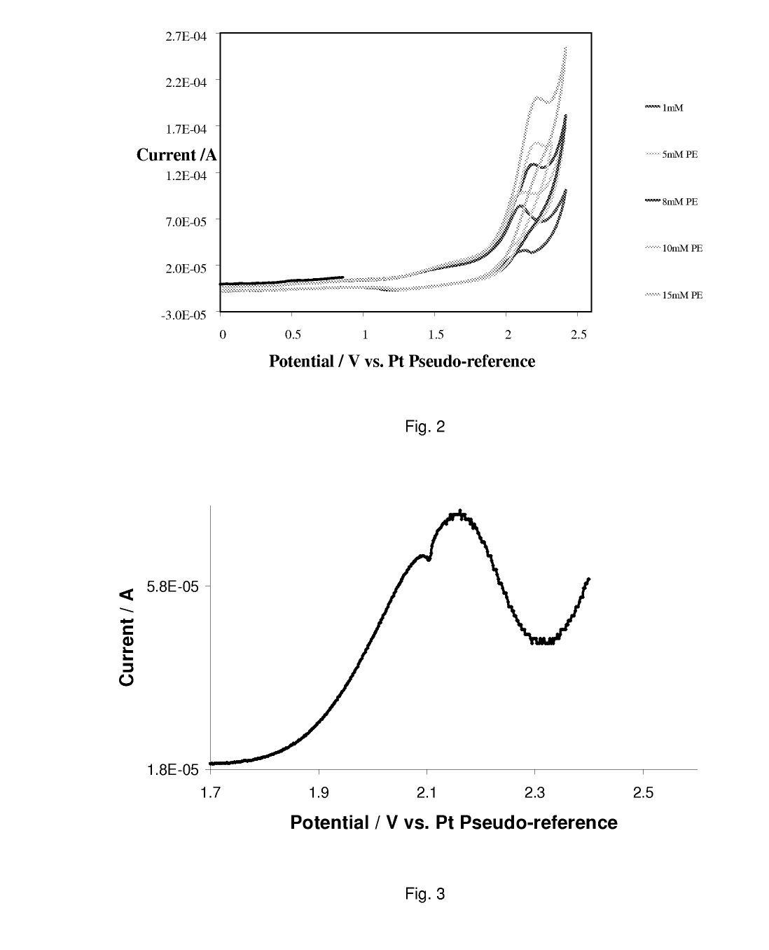

At low potentials, the TEMPO oxidation peak was found to increase with 2,6-lutidine, suggesting that the initial responses were mainly due to the simultaneous increase of 2,6-lutidine. When scanned to a much higher potential, an oxidation peak at 2.2 V was found (FIG. 2). Scans were made on various background solutions to see the potential window. When only the NaClO₄ electrolyte was present in solution, the potential window ended at 2.2 V, but when TEMPO and 2,6-lutidine were also present, the potential window edge shifted to 2.5 V. Therefore, the peak occurred within the window, and was not due to breakdown of the background solution.

The 2.2 V oxidation peak was found to depend upon the PE concentration. Square wave voltammetry, a more sensitive technique than CV, was employed to quantify this effect (FIG. 3). When the ionization potential (iₚ) of the 2.2 V peak was plotted against concentration, an excellent linear fit was found. The 2.2 V peaks comprised a slight shoulder, suggesting that the alcohol adsorbs onto the Pt surface before oxidation occurs. Similar results were obtained for both platinum and glassy carbon electrodes.

A solution containing only 10 mM PE and 0.2 M NaClO₄ background electrolyte was made up. A significant peak of similar height and shape to the one found when TEMPO was present was found, confirming that the peak was unrelated to the presence of TEMPO. Next, a solution containing only 10 mM ethanol and BG electrolyte was tested for comparison. No peaks were found in the corresponding CV. The absence of a peak here further indicates the 2.2 V peak is directly related to the presence of the alcohol. The effect of the background electrolyte (NaClO₄) on the system was also determined. NaClO₄ has oxidizing powers and so its presence may have lowered the energy required to oxidize PE. To test whether this was the case, a new, non-oxidising background electrolyte, ammonium hexafluorophosphate (NH₄PF₆) was used. A peak occurred at 2.05 V when PE was added to this background, and was of comparable height to the peak found at 2.2 V with 10 mM PE and NaClO₄ background. Therefore, the presence of an oxidizing agent such as NaClO₄ was not necessary for oxidation to occur.

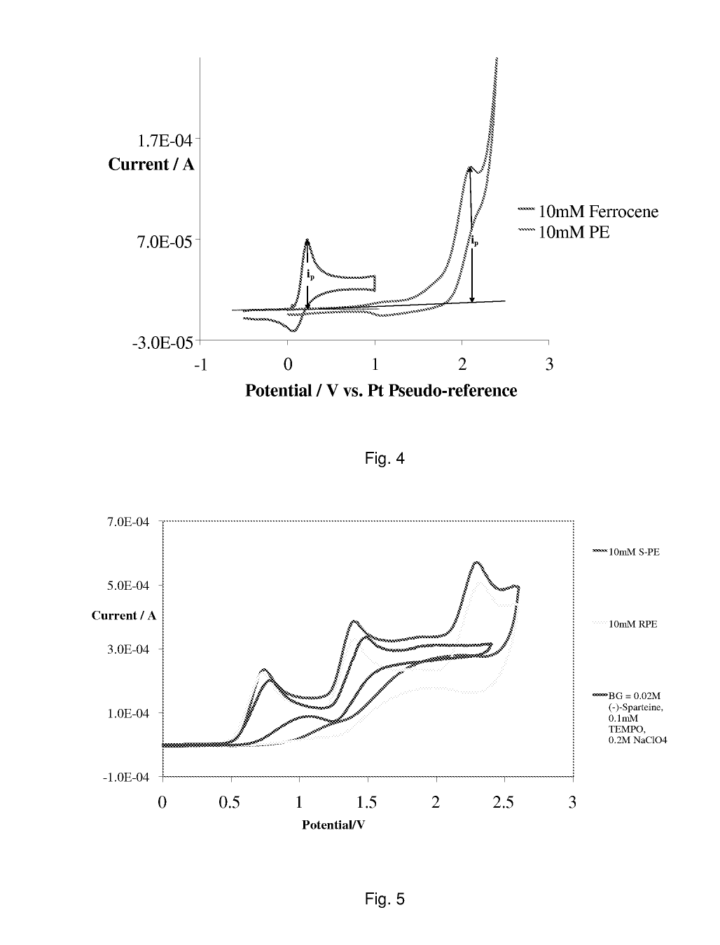

CVs were performed on a solution containing 10 mM ferrocene in a 0.2 M NaClO₄ background. The ferrocene/ferrocinium oxidation is a one-electron process. If the peak at 2.2 V relates to a two-electron oxidation, then a 10 mM PE solution should give an iₚ of roughly twice the size of the ferrocene oxidation. As FIG. 4 shows, the PE and ferrocene oxidation gave iₚ values of 1.33×10⁻⁴ A and 6.74×10⁻⁵ A respectively, which is approximately 2:1. Hence, it can be concluded that the 2.2 V peak is attributable to a two-electron oxidation of PE. This process can be described as an EE mechanism in which both electrons are transferred at the same potential; if the electrons were transferred in consecutive steps, then two peaks of similar magnitude to the ferrocene peak would have been observed.

The response of the system was also determined using a rotating disk electrode. Again, a step at 2.3 V, assigned to direct oxidation of PE, was found to respond to the alcohol concentration.

In conclusion, the peak at 2.2 V in the NaClO₄ background can be assigned to the direct two electron oxidation of PE at the electrode surface. This finding was unexpected; alcohol oxidation was previously thought to occur only at high potentials, thereby requiring the presence of an electron mediator for detection to be possible.

### Example 2

### Resolution of 1-phenylethanol by Direct Oxidation in the Presence of a Chiral Base ((−)-Sparteine)

### Experimental

Both an aqueous (with a 1 M KCl supporting electrolyte) and non-aqueous (acetonitrile, with 0.2 M NaClO₄ supporting electrolyte) solvent were investigated. In the acetonitrile tests, BG CVs (between 0V and 2.5 V, at 50 mV/s) and SWVs (0-2.6 V, at 100 mV/s) were recorded on solutions (10 cm³) containing:
a. NaClO₄ (0.2 M), and TEMPO (0.15 mM)
b. NaClO₄ (0.2 M), TEMPO (0.15 mM) and (−)-sparteine (0.02 M)

Solutions (10 cm³) containing TEMPO (0.15 mM), (−)-sparteine (0.02 M), NaClO4 (0.2 M) and S- or R-PE (0.01 M) were prepared and characterized by CV (between 0 V and 2.6 V, at 50 mV/s) and SWV (0-2.6 V, at 100 mV/s). A GCE WE, Pt flag auxiliary electrode and a Pt wire pseudo-reference electrode were used.

In the aqueous tests, solutions (10 cm³) containing TEMPO (0.1 mM), (−)-sparteine sulphate (0.04 M) and S- or R-PE (0.02 M) were prepared and characterized by CV (between 0 V and 1.0 V, at 50 mV/s). The auxiliary electrode was a platinum flag, a Pt working electrode was used, and the reference electrode was a Ag/AgCl electrode. Potential values were referred to the Ag/AgCl electrode.

### Results

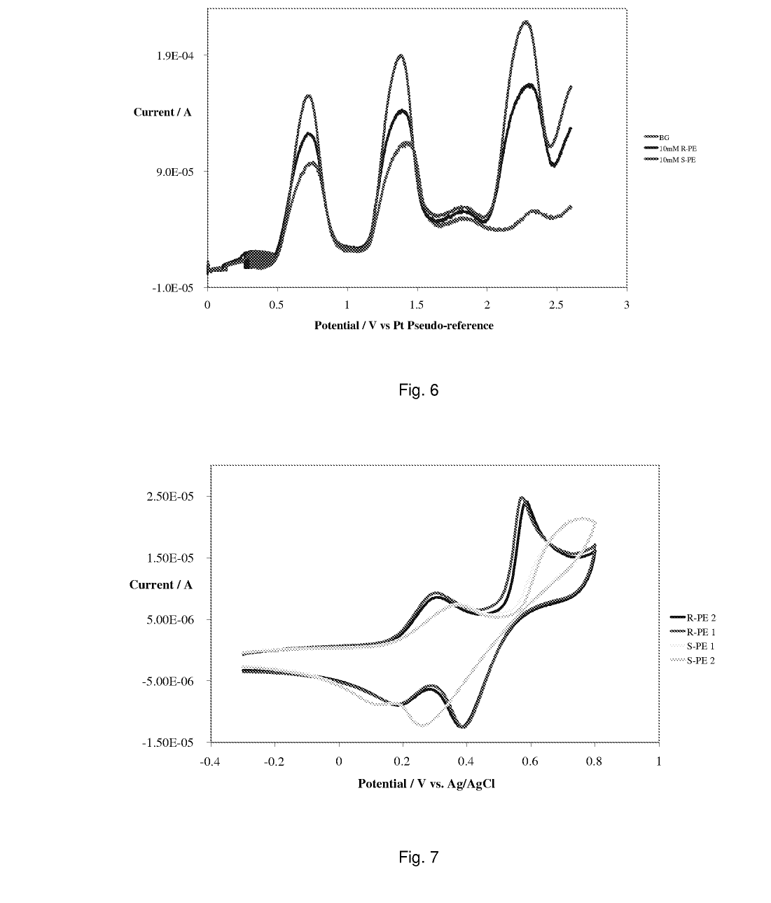

As FIGS. 5 and 6 show, the direct oxidation of PE exhibited enantioselectivity. This implies that addition of a suitable base, in this case (−)-sparteine, facilitates direct electrochemical PE oxidation. No enantioselectivity was observed when the sparteine salt was used. This is attributable to the (−)sparteine being in a di-protonated state and therefore not basic.

### Example 3

### Synthesis of a Cofactor Comprising an Electron Mediator

A compound of the formula (I) was synthesised according to Scheme 1:

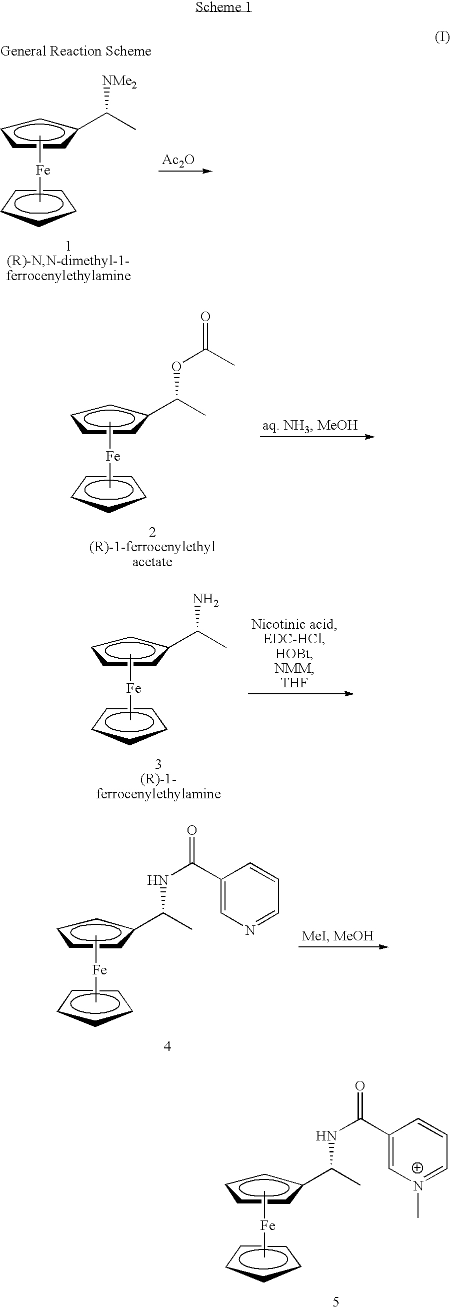

### Conversion of (R)—N,N-Dimethyl-1-Ferrocenylethylamine to (R)-Ferrocenylethyl Acetate

The starting material, (R)—N,N-dimethyl-1-ferrocenylethylamine, was characterized by ¹H NMR and ES⁺ mass spectrometry, to test the purity and for later comparison with the products. J values are given in Hz. R_{f} 0.61 (80% EtOAc: 20% hexane solvent system, silica plate), δ_{H} (200 MHz; CDCl₃; Me₄Si) 1.43 (3H, d, ³J 7, NCHCH₃), 2.06 (6H, s, 2×NCH₃), 3.60 (1H, q, ³J 7, NCH), 4.03-4.1.43 (9H, m, Fc), m/z (ES⁺) 258 (11% M+Na⁺), 213 (100, vinyl ferrocene+H⁺).

Two portions of (R)—N,N-dimethyl-1-ferrocenylethylamine (2×500 g) were then placed in two 10 ml tubes designed for use in a microwave. Each portion was dissolved in acetic anhydride (1.5 cm³) with stirring to ensure a complete mixing. The tubes were sealed and placed in a microwave oven (Biotage, model Initiator sixty) which was set at 100° C. for two minutes. After cooling, the dark red solution was poured into ether (50 cm³) and extracted with three 25 cm³ portions of saturated sodium carbonate solution. The organic phase was then extracted with two 25 cm³ portions of distilled water. The organic layer was dried over sodium sulphate, and after filtration the solvent was removed in vacuo to give a browny orange oil (0.85 g, 80%), R_{f} 0.72 (80% EtOAc: 20% hexane solvent system, silica plate), δ_{H}(200 MHz; CDCl₃; Me₄Si) 1.56 (3H, d, ³J 6, OCHCH₃), 2.04 (3H, s, CO₂CH₃), 4.15-4.30 (9H, m, Fc), 5.84 (1H q, ³J 7, OCH), m/z (ES⁺) 295 (28% M+Na⁺), 213 (100, vinylferrocene+H⁺).

### Conversion of (R)-Ferrocenylethyl Acetate to (R)-Ferrocenylethyl Amine

(R)-Ferrocenylethyl acetate (0.85 g) was dissolved in methanol (30 cm³) and concentrated aqueous ammonia solution (20 cm³) was added. After stirring for ten minutes, the mixture was placed into four 20 cm³ tubes (designed for use with the microwave). Each tube was placed in the microwave and heated at 100° C. for five minutes. After cooling, the methanol was removed in vacuo, and the oily residue was dissolved in 10% phosphoric acid (50 cm³). This solution was extracted twice with two 25 cm³ portions of ether. The aqueous phase was adjusted to approximately pH 11 with solid sodium carbonate, then extracted with three 25 cm³ portions of ether. The organic layer was washed with two 30 cm³ portions of brine and then dried over sodium sulphate. The solution was filtered and the solvents were removed in vacuo. An orange viscous oil, (0.279 g, 39%) was obtained. R_{f} 0.08 (80% EtOAc: 20% hexane solvent system, silica plate), δ_{H} (200 MHz; CDCl₃; Me₄Si) 1.36 (3H, d, ³J 7, NCHCH₃), 1.46 (2H, br s, NH₂), 3.75 (1H, q, ³J 7, NCH), 4.11-4.20 (9H, m, Fc), m/z (ES⁺) 252 (2.5% M+Na⁺), 213 (100, vinylferrocene+H⁺)

### Coupling of (R)-Ferrocenylethyl Amine to Nicotinic Acid

| | | | | Moles/ | Equivalents |
|---|---|---|---|---|---|
| | Mass/ | Volume/ | | ×10⁻⁴ | (relative to |
| Material | g | cm³ | Mᵣ | mol | amine) |
| (R)-Ferrocenyl- | 0.0301 | | 229.09 | 1.31 | 1 |
| ethyl Amine | | | | | |
| Nicotinic Acid | 0.0164 | | 123.11 | 1.33 | 1 |
| HOBt | 0.0216 | | 135.13 | 1.60 | 1.2 |
| EDC-HCl | 0.0307 | | 191.71 | 1.60 | 1.2 |
| NMM | | 0.0293 | 101.15 | 2.67 | 2 |

Nicotinic acid (0.151 g) was dissolved in THF (8 cm³) and the solution was stirred at room temperature. HOBt (0.198 g) was added, followed directly by NMM (0.238 cm³). The mixture was cooled to approximately 0° C. in an ice bath, then EDC-HCl (0.281 g) was added. The solution was stirred for five minutes, then a solution of (R)-Ferrocenylethyl Amine (0.279 g) in THF (4 cm³) was added. Stirring was maintained, and the mixture was allowed to warm to room temperature overnight. TLC (involving an 80% ethyl acetate 20% hexane solvent system, and silica plates) was used to follow the reaction. Product spots appeared at R_{f} 0.18 (80% EtOAc: 20% hexane solvent system, silica plate). The reaction mixture was poured into 1M HCl (30 cm³) and extracted with two 20 cm³ portions of ethyl acetate. The organic layer was washed with saturated sodium bicarbonate solution (2×25 cm³ portions), then dried over magnesium sulphate and filtered. Solvent was removed in vacuo, and the crude product (0.289 g) was purified by column chromatography on silica (initial solvent system 30% EtOAc: 70% hexane, with polarity eventually increased to 80% EtOAc: 20% hexane). The pure product (0.255 g, 63%) was obtained as orangey yellow crystals, δ_{H} (400 MHz; CDCl₃; Me₄Si) 1.53 (3H, d, ³J 7, NCCH₃), 4.00-4.22 (9H, m, Fc), 5.02 (1H, quintet, ³J 7, NCH), 6.35 (1H, br s, NH), 7.35 (1H, dd, ³J 5 and 3, Hc), 8.08 (1H, d, ³J 7, Hd), 8.66 (1H, d, ³J 4, Hb), 8.90 (1H, s, Ha), m/z (ES⁺) 357 (25% M+Na⁺), 335 (100, M+H⁺), 213 (13, vinyl ferrocene+H⁺).

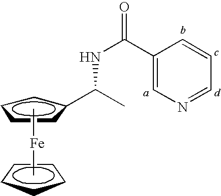

### Methylation of the Amide

The pure amide from the previous step (0.255 g) was dissolved in methanol (3 cm³) and excess MeI was added (3 cm³). The mixture was stirred at room temperature and monitored by TLC (80% EtOAc: 20% hexane). After two days, most of the amide had been converted to the methylated product. The solvent and excess MeI were removed by rotary evaporation, and the resultant product was dried on the vacuum line, to give an oily amorphous material. The amorphous material was washed with three 2 cm³ portions of MeI (because the unreacted amide was soluble and the methylated form was insoluble). After each washing, the solution containing amide and MeI was removed by pipette and kept for future use. The product was dried in vacuo and the methylated amide was obtained as light orangey brown crystals, (0.237 g, 89%), R_{f} 0.00 (80% EtOAc: 20% hexane solvent system, silica plate), δ_{H} (400 MHz; CDCl₃; Me₄Si) 1.66 (3H, d, ³J 7, NCCH₃), 4.00-4.50 (9H, m, Fc), 5.18 (1H, quintet, ³J 7, NCH), 7.88 (1H, br t, ³J 7, Hc), 8.51 (1H, br d, ³J 8, Hb), 8.75 (1H, br s, Ha), 8.86 (1H, br d, ³J 8, Hd), 9.70 (1H, s, NH), m/z (ES⁺) 350 (23%, M+H⁺), 349 (100, M⁺).

### Example 4

### Electrochemical Characterisation of the Chiral Mediator-Cofactor Mimic

Oxidation of 1-phenylethanol was then performed using the mediator-cofactor of Example 3 and horse liver ADH.

Phosphate buffer (pH 7 at 25° C.) was used as the solvent and electrolyte in all of the solutions made in this section. Solutions (10 cm³) containing chiral cofactor (1 mM), ADH (0.4 units/a) and R- or S-PE were prepared and characterized by CV (between −0.3 V and 0.8 V, at 50 mV/s). The auxiliary electrode was a platinum flag, the WE was a GCE, and the reference electrode was a Ag/AgCl electrode. Potential values were referred to the latter electrode. Tests with horse liver ADH gave an enantiomeric response (FIG. 7). In the presence of this enzyme, the peak separation of the ferrocene/ferrocinium interconversions was increased, implying that the process was becoming less reversible. This effect was more pronounced with the S-enantiomer. All peak potentials were shifted in the presence of the S-enantiomer. An extra redox process at higher potentials was observed. Desirable enantioselectivity for the R-enantiomer was found in this oxidation peak at 2.50V.

1. A method of detecting an alcohol in a sample, which comprises:
(a) contacting the sample with working and counter electrodes in the presence of an electrolyte, wherein the contacting takes place under conditions such that the alcohol undergoes direct oxidation at the working electrode; and
(b) determining the electrochemical response of the working electrode to said direct oxidation.

2. The method according to claim 1, wherein the alcohol is a chiral alcohol.

3. (canceled)

4. The method according to claim 2, wherein the alcohol is 1-phenylethanol.

5. The method according to claim 1, wherein the contacting takes place in the presence of a base.

6. The method according to claim 5, wherein the base is 2,6-lutidine.

7. The method according to claim 5, wherein the base is (−)-sparteine.

8. (canceled)

9. (canceled)

10. (canceled)

11. A method of detecting an analyte in a sample, comprising:
(a) contacting the sample with an enzyme and a cofactor, wherein the enzyme and the cofactor catalyse a detectable reaction of said analyte, and wherein the cofactor comprises a moiety which is capable of acting as an electron mediator; and
(b) detecting said reaction.

12. The method according to claim 11, wherein the analyte is a chiral analyte.

13. (canceled)

14. The method according to claim 12, wherein the analyte is a chiral alcohol.

15. The method according to claim 14, wherein the alcohol is 1-phenylethanol.

16. (canceled)

17. (canceled)

18. The method according claim 11, wherein the enzyme is an alcohol dehydrogenase or a mimic thereof.

19. (canceled)

20. The method according to claim 11, wherein the cofactor is a chiral cofactor.

21. The method according to claim 11, wherein the cofactor comprises a nicotinamide group or a derivative thereof.

22. The method according to claim 11, wherein the cofactor comprises a ferrocenyl group.

23. The method according to claim 11, wherein the cofactor is a compound of the formula (I) or a derivative thereof:

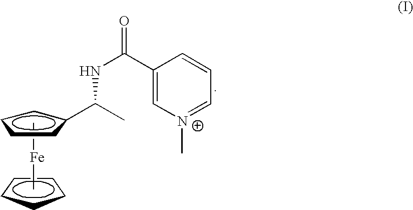

24. The method according to claim 11, wherein the contacting takes place in the presence of a base.

25. The method according to claim 24, wherein the base is chiral.

26. The method according to claim 11, wherein the reaction is detected electrochemically.

27. A cofactor for an enzyme, wherein the cofactor comprises a moiety capable of acting as an electron mediator.

28. The cofactor according to claim 27, which is a chiral cofactor.

29. (canceled)

30. (canceled)

31. The cofactor according to claim 28, wherein the cofactor comprises a nicotinamide group.

32. The cofactor according to claim 28, wherein the cofactor comprises a ferrocenyl group.

33. The cofactor according to claim 28, which is a compound of the formula (I) or a derivative thereof:

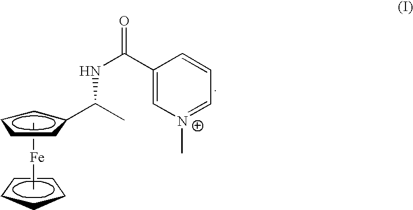

34. (canceled)

35. (canceled)

36. An electrochemical sensor comprising a cofactor of claim 27.

37. A sensor for detecting a chiral analyte, which comprises:
(a) means for resolving an enantiomeric mixture of said analyte; and
(b) an electrochemical sensor for detecting at least one resolved enantiomer.

38. The sensor according to claim 37, which comprises a chamber comprising a chiral chromatography column.

39. The sensor according to claim 38, which comprises a chamber for vaporizing a liquid sample prior to contacting with the chromatography column.

40. The sensor according to claim 39, wherein the column is a gas chromatography column.

41. (canceled)

42. (canceled)

43. (canceled)

44. (canceled)

45. A method of detecting a chiral analyte in a sample, which comprises:
(a) resolving a enantiomeric mixture of said analyte; and
(b) detecting at least one of the resolved enantiomers electrochemically.

46. The method according to claim 45, wherein the analyte comprises a chiral alcohol.

47. The method according to claim 46, wherein the alcohol is 1-phenylethanol.

48. The method according to claim 45, wherein resolution is performed using chiral chromatography.

49. The method according to claim 48, wherein the sample is in gaseous form and resolution is performed using chiral gas chromatography.

50. (canceled)

51. (canceled)

52. (canceled)

53. (canceled)

54. (canceled)
